(19) United States
(12) Patent Application Publication
(10) Pub. No.: US 2026/0030797 A1
(43) Pub. Date: Jan. 29, 2026

(54) EFFICIENT INTERPOLATION OF COLOR FRAMES

(71) Applicant: Arm Limited, Cambridge (GB)

(72) Inventors: Liam James O'Neil, Stretford (GB); Joshua James Sowerby, London (GB); Yanxiang Wang, Sale (GB); Matthew James Wash, Pampisford (GB)

(21) Appl. No.: 18/783,213

(22) Filed: Jul. 24, 2024

(51) Int. Cl. G06T 11/00

(52) U.S. Cl. CPC G06T 11/001

(57) ABSTRACT

First interpolated optical flow data is based, at least in part, on an optical flow from a preceding frame, an optical flow from a following frame, or a combination thereof, with a reduced resolution. First interpolated motion vector data based, at least in part, on motion vectors from a preceding frame, a following frame, or a combination thereof, with a reduced resolution. A motion vector nearest in depth is determined from among the first interpolated motion vector data, or an optical flow nearest in depth is determined from among the first interpolated optical flow data, or a combination thereof, for each pixel of an interpolated frame, and are used to selectively gather one or more color signal values for at least some pixels in the interpolated frame from the preceding frame or the following frame, or a combination thereof.

### FIELD

The field relates generally to processing a rendered image, and more specifically to efficient interpolation of colored frames in rendered image sequences.

### BACKGROUND

Rendering images using a computer has evolved from low-resolution, simple line drawings with limited colors made familiar by arcade games decades ago to complex, photo-realistic images that are rendered to provide content such as immersive game play, virtual reality, and high-definition CGI (Computer-Generated Imagery) movies. While some image rendering applications such as rendering a computer-generated movie can be completed over the course of many days, other applications such as video games and virtual reality or augmented reality may entail real-time rendering of relevant image content. Because computational complexity may increase with the degree of realism desired, efficient rendering of real-time content while providing acceptable image quality is an ongoing technical challenge.

Producing realistic computer-generated images typically involves a variety of image rendering techniques, from rendering perspective of the viewer correctly, rendering different surface textures, and providing realistic lighting. But rendering an accurate image takes significant computing resources, and becomes more difficult when the rendering must be completed many tens to hundreds of times per second to produce desired framerates for game play, augmented reality, or other applications. Specialized graphics rending pipelines can help manage the computational workload, providing a balance between image quality and rendered images or frames per second using techniques such as taking advantage of the history of a rendered image to improve texture rendering. Rendered objects that are small or distant may be rendered using fewer triangles than objects that are close, and other compromises between rendering speed and quality can be employed to provide the desired balance between frame rate and image quality.

In some embodiments, an entire image may be rendered at a lower resolution than the eventual display resolution, significantly reducing the computational burden in rendering the image. In other examples, the number of frames rendered may be less than the number of frames presented for display, such as rendering at 60 frames per second while displaying images on a display with a refresh rate of 120 frames per second. As developers often choose to use advances in rendering and graphics processing unit (GPU) technology to produce higher-resolution images with enhancements such as ray tracing to improve the fidelity or visual quality of rendered images, frame rates of mobile games and other applications often do not keep pace with advances in display technology.

Some rendering systems therefore attempt to increase the perceived frame rate of rendered image sequences such as by interpolating between rendered image frames. But, generating an additional frame that exists between two previously-rendered frames in time is not an easy task, should desirably be performed with significantly less computational burden than actually rendering the additional frame for the interpolation process to be useful. Further, solutions that may work on desktop computers or video game consoles having high bandwidth and high power budgets may not be well-suited to portable or mobile devices such as smartphones or tablet computers.

For reasons such as these, it is desirable to perform frame interpolation for rendered image streams in a way that is computationally efficient and power efficient.

### BRIEF DESCRIPTION OF THE DRAWINGS

The claims provided in this application are not limited by the examples provided in the specification or drawings, but their organization and/or method of operation, together with features, and/or advantages may be best understood by reference to the examples provided in the following detailed description and in the drawings, in which:

FIG. 1 shows an image frame diagram illustrating interpolation between consecutive rendered image frames, consistent with an example embodiment.

FIG. 2 shows a block diagram of a rendered image stream frame interpolation process, consistent with an example embodiment.

FIGS. 3A-3B show a block diagram of a frame interpolation process employing reduced-resolution processing, consistent with an example embodiment.

FIG. 4 is a flow diagram of a method of using a neural network to generate a blended interpolated image frame, consistent with an example embodiment.

FIG. 5 is a flow diagram of a method of generating an interpolated image frame using reduced-resolution processing, consistent with an example embodiment.

FIG. 6 is a schematic diagram of a neural network, consistent with an example embodiment.

FIG. 7 shows a computing environment in which one or more image processing and/or filtering architectures (e.g., image processing stages, FIG. 1) may be employed, consistent with an example embodiment.

FIG. 8 shows a block diagram of a general-purpose computerized system, consistent with an example embodiment.

Reference is made in the following detailed description to accompanying drawings, which form a part hereof, wherein like numerals may designate like parts throughout that are corresponding and/or analogous. The figures have not necessarily been drawn to scale, such as for simplicity and/or clarity of illustration. For example, dimensions of some aspects may be exaggerated relative to others. Other embodiments may be utilized, and structural and/or other changes may be made without departing from what is claimed. Directions and/or references, for example, such as up, down, top, bottom, and so on, may be used to facilitate discussion of drawings and are not intended to restrict application of claimed subject matter. The following detailed description therefore does not limit the claimed subject matter and/or equivalents.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to aid in understanding these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

As graphics processing power available to smart phones, personal computers, and other such devices continues to grow, computer-rendered images continue to become increasingly realistic in appearance. These advances have enabled real-time rendering of complex images in sequential image streams, such as may be seen in games, augmented reality, and other such applications, but typically still involve significant constraints or limitations based on the graphics processing power available. For example, images may be rendered at a lower resolution than the eventual desired display resolution, with the render resolution based on the desired image or frame rate, the processing power available, the level of image quality acceptable for the application, and other such factors. Many developers elect to use available graphics resources to render with a high fidelity visual quality or resolution, compromising in other areas such as frame rate (or the number of frames rendered per unit of time). Many computer graphics applications such as advanced games therefore look substantially better than a decade ago, but do not make use of recent advances in display refresh rates.

Some approaches to addressing problems such as these may involve interpolating between rendered frames using an algorithm that is more computationally efficient than rendering the interpolated frame. Interpolation between rendered frames may be somewhat complex in that rendered objects may be moving not only side to side or up and down, but may also be moving toward or away from the viewer's vantage point (e.g., a rendered object may be changing in apparent size), may be accelerating, or may have shadows or other lighting effects not captured by motion vectors associated with the rendered objects. For reasons such as these, rendered frame interpolation algorithms have largely focused on desktop computer-grade high-performance and high-power discrete GPU devices, and are not low-power or mobile device-friendly.

Some examples presented herein therefore employ using various methods that are mobile device-friendly and consume less power and fewer computing resources, such as reduced-resolution motion vector scattering in generating an interpolated frame and using alpha blending coefficients generated via a neural network to select or blend between different warped interpolated frames on a per-pixel level.

In one such example, an interpolated output frame may be generated by creating a first interpolated optical flow frame based at least on a first preceding or following frame and optical flow from the first preceding or following frame, and creating a first interpolated motion vector frame based at least on a second preceding or following frame and motion vectors from the second preceding or following frame. The first interpolated optical flow frame and the first interpolated motion vector frame may be provided to a trained neural network to predict blending parameters for blending each of the first interpolated optical flow frame and the first interpolated motion vector frame, and the predicted blending parameters may be used to generate an interpolated output frame by applying the predicted blending parameters to the first interpolated optical flow frame and the first interpolated motion vector frame.

In another example, a method of creating an interpolated frame comprises creating first interpolated optical flow data based, at least in part, on an optical flow from a preceding frame, a following frame, or a combination thereof. The first interpolated optical flow data may have a resolution reduced relative to the respective preceding frame, following frame, or combination thereof. First interpolated motion vector data may also be created, based, at least in part, on motion vectors from a preceding frame, a following frame, or a combination thereof, and the first interpolated motion vector data may also have a resolution reduced relative to the respective preceding frame, following frame, or combination thereof. A motion vector nearest in depth from among the first interpolated motion vector data may be determined, or an optical flow nearest in depth from among the first interpolated optical flow data may be determined, or a combination thereof, for each pixel of an interpolated frame. One or more color signal values may be gathered for at least some pixels in the interpolated frame from the preceding frame or the following frame, or a combination thereof, based, at least in part, on the determined at least one nearest in depth motion vector, or at least one nearest in depth optical flow, or a combination thereof.

Examples such as these can use blending parameters predicted by a trained neural network to effectively determine whether motion vector or optical flow-based interpolated image frames are likely to produce the best image result in generating an interpolated image frame, such that the blending parameters can be used in a blending process using both motion vector and optical flow-based interpolated image frames. In some examples, use of reduced resolution for some steps, such as for neural network processing, generating interpolated motion vector or optical flow-based image frames, and warping or other processing of such image frames may help reduce the computational burden of generating interpolated image frames and reduce power consumption while having minimal visible effect on the fidelity or quality of the output interpolated image frame.

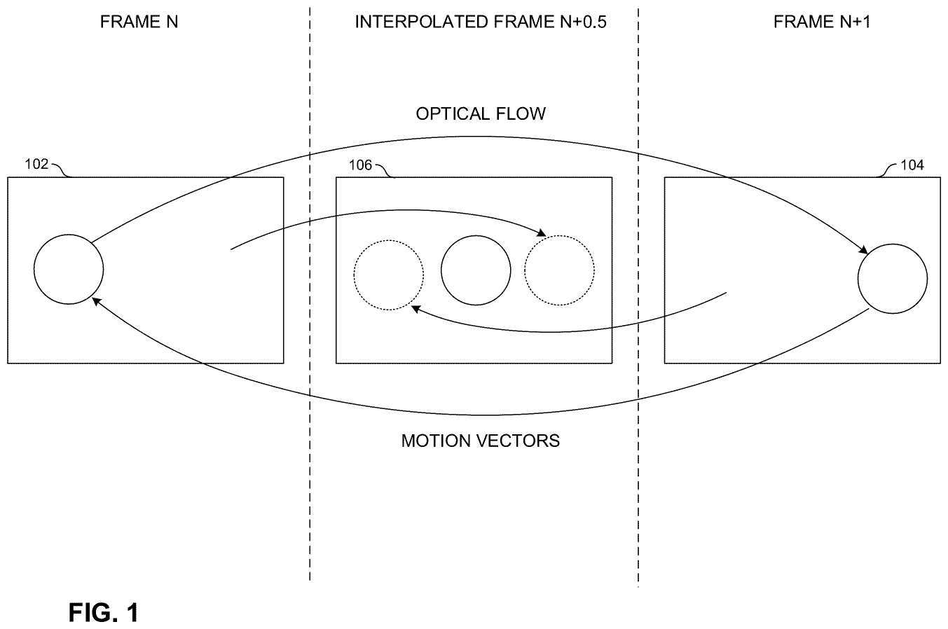

FIG. 1 shows an image frame diagram illustrating interpolation between consecutive rendered image frames, consistent with an example embodiment. Here, consecutive image frames N and N+1 are shown at 102 and 104, respectively. To increase the apparent frame rate of the rendered image stream, an interpolated image frame N+0.5 is generated as shown at 106. In this example, a single interpolated image frame is shown at a time centered between image frame N and image frame N+1, while other embodiments may include multiple interpolated image frames between rendered image frames, interpolated image frames spaced at intervals other than a whole-number multiple of the original image frame rate, or the like.

The interpolated image frame shown at 106 in this example reflects that the position of a round object, such as a ball, has moved to the right approximately half the distance of its movement between sequentially rendered image frames 102 and 104. In further examples, the movement of at least some objects between rendered image frames may further account for acceleration, such that the object may be placed somewhere other than the midpoint between its position in the frames preceding and following the interpolated frame.

The example interpolated frame 106 further illustrates how certain areas of the frame are disoccluded or no longer covered by the rendered ball object, resulting in the background or other rendered objects having greater depth becoming visible between frames due to the ball's movement. This is reflected by the balls in interpolated frame 106 shown using dashed lines, with arrows reflecting that these disoccluded areas may be selectively copied from the same areas of frames 102 and 104.

If the perspective of the camera changes between image frames or objects otherwise move between sequential image frames, the image frames may be warped in generating effects such as interpolation, disocclusion, and the like. In a simplified example, if the camera is panning to the right between frames 102 and 104 of the example of FIG. 1, this panning will desirably be accounted for in copying disoccluded elements of the background, illumination, or other objects into interpolated frame 106.

Motion vectors associated with objects such as the rendered ball of FIG. 1 may be used to help form an interpolated image of the ball or other objects such as in interpolated image frame 106, but may not account for differences in illumination, shadows, and other such features. Features such as these may be tracked separately from motion vectors in some examples using optical flow, which may track the movement of various features of an image across sequential image frames without prior knowledge of the objects rendered in the frames. While optical flow may be similar in some ways to motion vectors in that it tracks movement in image sequences, it may be less precise than tracking rendered objects. Although optical flow may be somewhat less accurate, it may produce visibly better tracking of things like lighting and shadows that are not rendered objects having associated motion vectors.

Motion vectors in the example of FIG. 1 are calculated from the perspective of the most recently-rendered frame, shown at 104, looking back to the preceding rendered frame 102, as shown by the motion vectors line and arrow near the bottom of FIG. 1. The rendering engine has knowledge of both the current frame (e.g. frame 104) and the prior rendered frame, and so can calculate the most up-to-date motion vectors looking back from the previous frame. Optical flow, in this example, may be calculated looking forward from a past frame to the current frame as represented by the optical flow line and arrow near the top of FIG. 1.

Motion vectors may be scattered or pushed into the interpolated frame of reference by multiplying motion vectors from image frame 104 on a per-pixel basis by 0.5, but this may result in write collisions such as where a rendered object is moving nearer or farther the viewer or camera's perspective between frames. In one such example, multiple pixels of a ball that is closer in rendered image frame 104 than in interpolated image frame 106 may map to the same pixel in interpolated image frame 106, causing write collisions and leaving some pixel locations unwritten. Similar problems may exist with optical flow, with scatter or push operations potentially including data collisions in some pixels and leaving some pixels unwritten.

Problems such as these may be addressed by using a depth buffer and pushing depth information along with motion vector or optical flow information into the interpolated frame of reference 106. If each scatter or push operation includes associated pixel depth information, methods such as retaining only the motion vector or optical flow vector associated with the nearest depth can ensure that only the most relevant motion vector or optical flow information is kept per pixel. In a more detailed example, the motion vector or optical flow vector having the minimum or nearest depth may be determined using expression [1] as follows:

$$warped ( x + {mv}_{x} ( x , y ) , y + {mv}_{y} ( x , y ) ) = min ( out ( x + {mv}_{x} ( x , y ) , y + m {v}_{y} ( x , y ) ) , in ( x , y ) ) \qquad [ 1 ]$$

where:
x and y are pixel coordinates of a pixel in the interpolated frame;
mvₓ(x, y) is the motion vector x component at pixel location (x, y);
mv_{y}(x, y) is the motion vector y component at pixel location (x, y);
warped (x+mvₓ(x, y), y+mv_{y}(x, y)) is the warped motion vector having the minimum or nearest depth;
(out (x+mvₓ(x,y), y+mv_{y}(x, y) is the motion vector previously stored as nearest to the camera or viewer's position; and
in (x, y) is the current motion vector being scattered into the pixel location (x, y).

Holes or unwritten pixels may further be filled using various techniques such as averaging, selecting a nearest neighbor, or other such methods. In one such example, the motion vector or optical flow vector having the nearest depth that is not a hole is selected from a 3×3 mask around the pixel having a hole, using expression [2] as follows:

$$filled ( {x}_{i} ) = {{⋃}_{depth ( {x}_{i} ) * holeMask ( {x}_{i} )}}^{{x}_{i} ∈ Ω} warped ( {x}_{i} )$$

where:
filled (xᵢ) is the filled motion vector or optical flow vector value of the previously empty location;
warped (xᵢ) is the warped motion vector or optical flow vector in the interpolated frame (FIG. 1 at 106) . . .
depth (xᵢ) is the warped depth in the interpolated frame (FIG. 1 at 106)
holeMask (xᵢ) is a binary hole mask computed during scattering, where 0 corresponds to a pixel that has not had any motion vector or depth value scattered into its interpolated position and 1 is a valid location; and
xᵢ∈Ω is a pixel location within a window (e.g., 3×3) around each pixel denoted as a hole that is dilated.

Once the nearest depth is known via a scattering pass, the depth information can be used to warp preceding and following frames into the interpolated frame position if the depth value associated with the pixel matches the known nearest depth associated with the pixel. The depth of the nearest object per pixel for preceding and following frames may further be used to identify disocclusions, such as where the depth difference exceeds a threshold value, and may be used to flag such pixels to a neural network as possibly disoccluded (or occluded) pixels. In a further example, methods described herein may be acceleration-aware, such as where warping, depth, disocclusion, or other such calculations are computed using knowledge of acceleration of a rendered object rather than simply using linear interpolation.

Color information, such as RGB values for pixels, could similarly be scattered or pushed into the interpolated frame using a scatter operation, but this again is computationally somewhat expensive as it cannot be parallelized and involves random access reads to preceding and/or subsequent image frames. Some examples therefore may scatter or push motion vectors and/or optical flow vectors into the interpolated frame 106's frame of reference, along with depth information from preceding and following rendered image frames. Although reducing the resolution of color data copied to the interpolated frame 106 may show subsampling-like artifacts, the resolution of the scattered motion vectors and/or optical flow vectors may be reduced relative to the resolution of the preceding and following rendered image frames without creating such visible artifacts and speed up the relatively time-consuming scatter operation and increasing computational efficiency of subsequent warping operations.

The reduced resolution motion vectors and optical flow may be used to gather color frame information into the interpolated frame 106 by extrapolating or expanding the resolution of the motion and/or optical flow vectors, such as by using bilinear interpolation, and iterating over the interpolated space rather than the preceding and/or following rendered image frame space. Gathering color information using depth information and motion vectors and/or optical flow vectors enables gathering color information into the interpolated image space 106 rather than scattering information from the preceding and/or following rendered images, avoiding write collisions and holes in the gathered color information.

In a more detailed example, the motion vector and optical flow vector information can be scaled to gather color information from the preceding and following frames, generating preceding and following gathered warped motion vector frames and preceding and following gathered warped optical flow frames. These four frames may be used as input to a neural network to generate blending coefficients or alpha for blending between these four frames, such that the blending coefficients may be subsequently applied to the four frames in a blending operation to generate an output interpolated image frame.

The neural network in various examples may be trained using sequentially rendered frames, such as using time T=0 and T=2 rendered image frames to generate inputs and T=1 rendered frames to generate blending values as predicted outputs. The neural network may thereby learn to identify image features such as shadows that are better represented by optical flow than by motion vectors, learn to spot disocclusions, and other such image characteristics as may be useful in generating the predicted output. Although the neural network in this example may perform blending value compositing using color domain information, other examples may use motion vector and optical flow loss as well or in place of such color domain information. In one such example, motion vector and optical flow vector information may point in different directions, so can train network to make a binary choice between motion vector and optical flow frames.

Because the blending coefficients are not based on color space and color information is derived directly from preceding and following rendered image frames, methods such as those described herein may work on High Dynamic Range (HDR) video or video using other color spaces or encodings

These examples show how use of motion vectors and optical flow at reduced resolution can decrease the computational burden on interpolating between rendered image frames without significantly impacting interpolated image quality, and how a neural network can be used to predict blending values between motion vector-derived interpolated image pixels and optical flow-derived image pixels within a single interpolated image frame. Using methods such as these may significantly improve performance of rendered image interpolation in devices with limited compute resources or a limited power budget, such as mobile devices like smartphones or tablet computers.

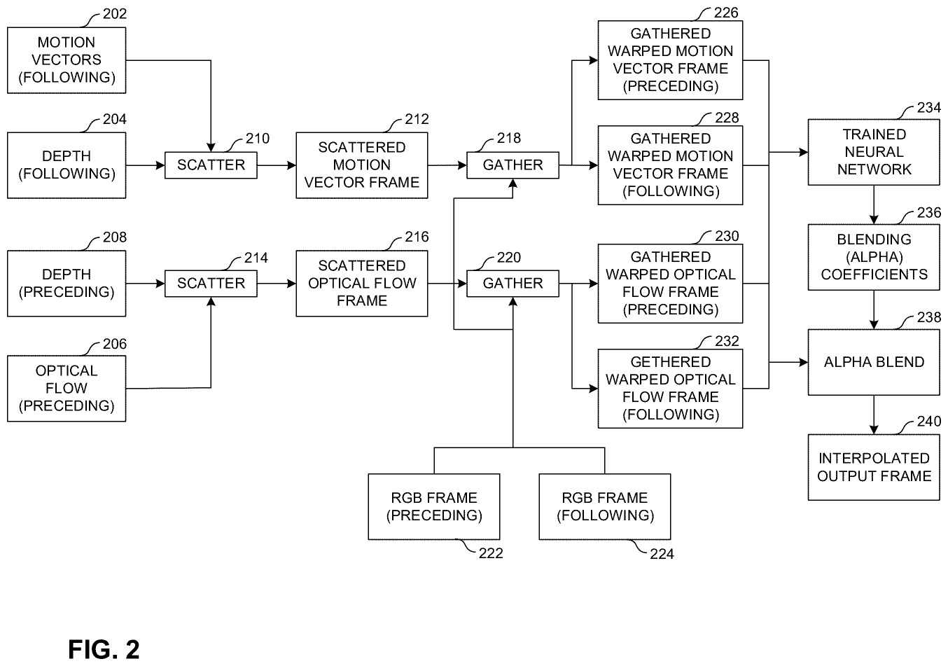

FIG. 2 shows a block diagram of a rendered image stream frame interpolation process, consistent with an example embodiment. Here, motion vector frame 202 and motion vector depth frame 204 are derived from a rendered image frame immediately following the interpolated frame being generated in a rendered image sequence, and optical flow frame 206 and optical flow depth frame 208 are derived from a rendered image frame immediately preceding the interpolated frame being generated. The motion vectors 202 and associated motion vector depth information are scattered at 210 into a motion vector frame 212 that is time-aligned with the interpolated image frame being generated. The optical flow 206 from the preceding image frame and associated depth information 208 are similarly scattered at 214 into a scattered optical flow frame 216 that is also time-aligned with the interpolated image frame being generated. These scattered motion vector frames 212 and scattered optical flow frames 216 may in some examples employ methods such as those described in FIG. 1 to avoid write collisions and holes in scattered data, such as selecting the nearest depth scatter candidate for each pixel and filling any holes or unfilled pixels with a neighboring pixel value having the nearest depth that is not also a hole.

The scattered motion vector frame 212 may then be used in a gather operation to gather color information from preceding or following RGB frames 222 and 224, thereby generating a pair of gathered and warped motion vector RGB frames-one based on the preceding RGB frame as shown at 226 and one based on the following RGB frame as shown at 228. Gather operation 220 is similarly performed based on the scattered optical flow frame 216, generating gathered warped optical flow frame 230 based on color information from the preceding RGB frame 222 and gathered warped optical flow frame 230 based on the following RGB frame 224.

These four RGB frames each contain different estimates of the color information for the interpolated output image frame, based on either the preceding or following RGB frame's color information and on either motion vectors or optical flow. Selecting from among these four RGB frames 226-232 for inclusion in the interpolated output image frame is performed here by providing the four image frames, image frame depth information, and other such information to a trained neural network 234. The trained neural network in various examples may be trained using rendered data to recognize disocclusions, to differentiate between moving rendered objects and light or other optical flow phenomena, and to recognize other information relevant in choosing between the four RGB frame candidates 226-232.

The neural network 234 provides as an output blending coefficients (or alpha coefficients) for each pixel location for each of the four RGB image frame candidates 226-232, such that the blending coefficients may be used in an alpha blend operation at 238 to blend the four RGB image frame candidates together in the indicated per-pixel proportions to generate an interpolated output frame 240.

In further examples, the resolution of one or more steps in the process shown here may occur at reduced resolution to reduce the computational burden and power consumed in various steps, such as reducing the resolution at which motion vectors and optical flow are scattered from the preceding and following RGB frames at 210-216, warping the depth of the motion vectors and optical flow, performing hole filling in scattered interpolated image frames, generating RGB candidate frames at 226-232 using gather operations 218-220, using the neural network 234 to generate blending coefficients 236, and the like. Interpolated output frame 240 may optionally be upscaled to the original resolution such as during postprocessing after the alpha blend step 238 to retain image fidelity of the interpolated frame, making the interpolated output frame appear substantially similar to a rendered and ray-traced output frame.

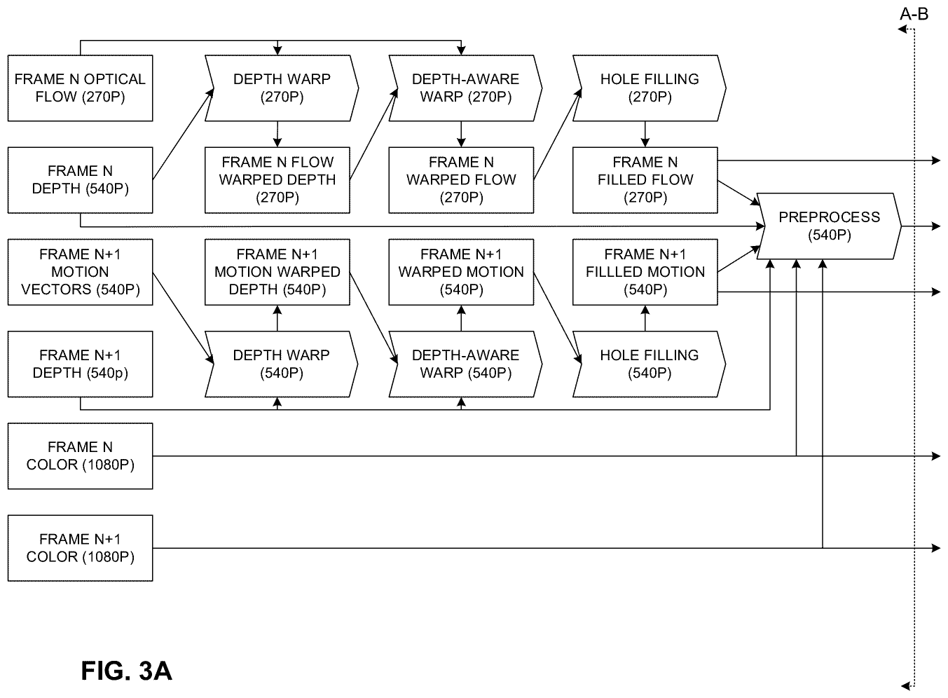

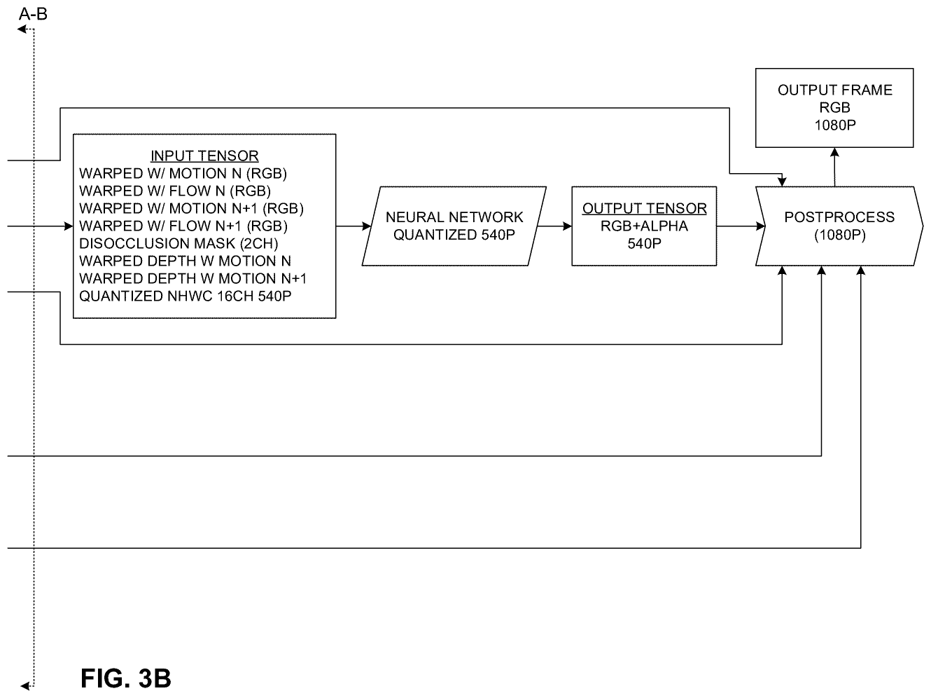

FIGS. 3A-3B show a block diagram of a frame interpolation process employing reduced-resolution processing, consistent with an example embodiment. Here, preceding frame N color information is provided at full 1080P (or 1920×1080 pixel, Progressive) resolution, while preceding frame optical flow information is downsampled to 270P (or one-sixteenth the number of pixels of the preceding 1080P image frame) and preceding frame depth information is downsampled to 540P (or one-quarter the number of pixels of the preceding 1080P image frame). Motion vector information and depth information from the following frame N+1 are similarly downsampled to 540P. Motion vector information is in this example downsampled to a higher resolution than optical flow because the motion vectors contain more accurate information than the optical flow, so a visible benefit to using relatively higher resolution motion vectors may be observed. These reduced resolutions are maintained through warping and hole-filling steps for both motion vectors and optical flow, but optical flow is upsampled to 540P for preprocessing as shown at the right side of FIG. 3A. Although this example shows generation of a warped and hole-filled optical flow frame based on a preceding frame and generation of a warped and hole-filled motion vector frame based on a following frame, further examples may also include a warped and hole-filled optical flow frame based on the following frame and generation of a warped and hole-filled motion vector frame based on the preceding frame as in the example of FIG. 2.

In FIG. 3B, these four warped and hole-filled optical flow and motion vector frames based on preceding and following frames are provided as part of an input tensor to the neural network, along with a disocclusion mask for each of the preceding and following frames, warped depth with motion for each of the preceding and following frames, and other information. The data may be provided in Number of samples, Height, Width, Channels format (NHWC) or another suitable format as reflected in the input tensor block of FIG. 3B, which in a further example may be dependent on or influenced by the configuration of the neural network. The input tensors and neural network are in this example operating with 540P image frames, and output an output tensor including blending coefficients (or alpha coefficients) at 540P resolution. These blending coefficients may be used in a postprocessor along with original preceding (N) and following (N+1) image frames at 1080P and warped and filled motion vector and optical flow image candidate frames to blend the image candidate frames to generate an output RGB frame at 1080P resolution. Original 1080P preceding and following image frames in a further example may be used to warp the blended frame to generate the output RGB frame as needed.

In a more detailed example, the depth warp pass of FIG. 3A is performed using relatively computationally expensive atomic operations, so may include recording a minimum depth to identify a closest pixel for both optical flow and motion vectors at reduced resolution. The warp operation reflected in FIG. 3A may further be performed with depth awareness, such as using the gather operation to ensure that only pixels having the nearest depth value are written to warped. The hole filling pass of FIG. 3A may use a dilation equation similar to that described in conjunction with the examples of FIGS. 1 and 2, such as using a 3×3 grid of depth of surrounding pixels to select a nearest candidate pixel to fill the hole. In a more detailed example, a small epsilon may be added to each written value to ensure that true zeros all actually represent holes that should be filled using a process such as that described here.

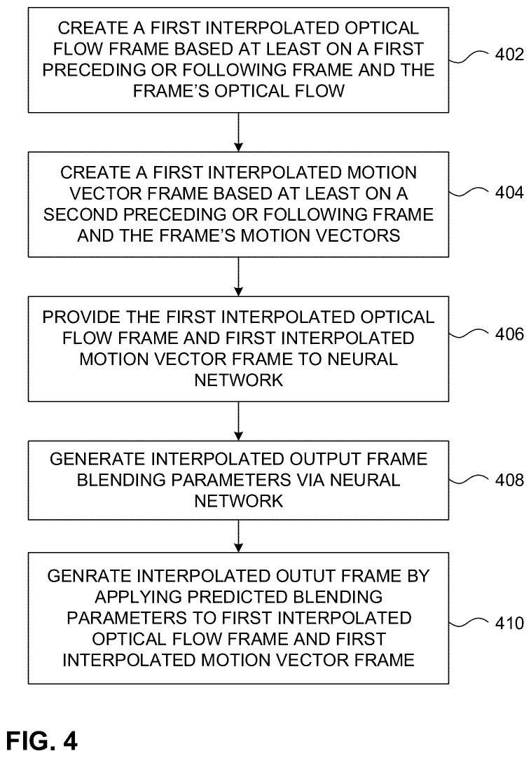

FIG. 4 is a flow diagram of a method of using a neural network to generate a blended interpolated image frame, consistent with an example embodiment. Here, a first interpolated optical flow frame is generated at 402, based at least on a first preceding or following frame and the frame's optical flow. In a further example, interpolated optical flow frames may be generated based on each of the preceding and following image frames and their respective optical flow. At 404, a first interpolated motion vector frame is similarly generated based at least on a second preceding or following frame and that frame's motion vectors, and in further examples may include interpolated motion vector frames based on each of the preceding and following image frames and their respective motion vectors. In further examples, the interpolated motion vector and optical flow frames may be populated using a scatter-and-gather method as described in previous examples, may be warped, may be hole-filled, and/or may undergo other processing. The interpolated motion vector and optical flow frames may also in some examples be generated and/or processed at a resolution reduced from the original preceding and following image frames, such as to conserve computational resources or power.

The interpolated optical flow frame or frames and the interpolated motion vector frame or frames are provided to a neural network at 406, which generates interpolated output frame blending parameters as an output tensor. These blending parameters may be used along with the interpolated optical flow and motion vector frames to selectively blend the interpolated optical flow and motion vector frames to generate an interpolated output image frame at 410, which in a further example may be at a higher resolution than the interpolated optical flow and motion vector frames to match the resolution of the original preceding and following image frames.

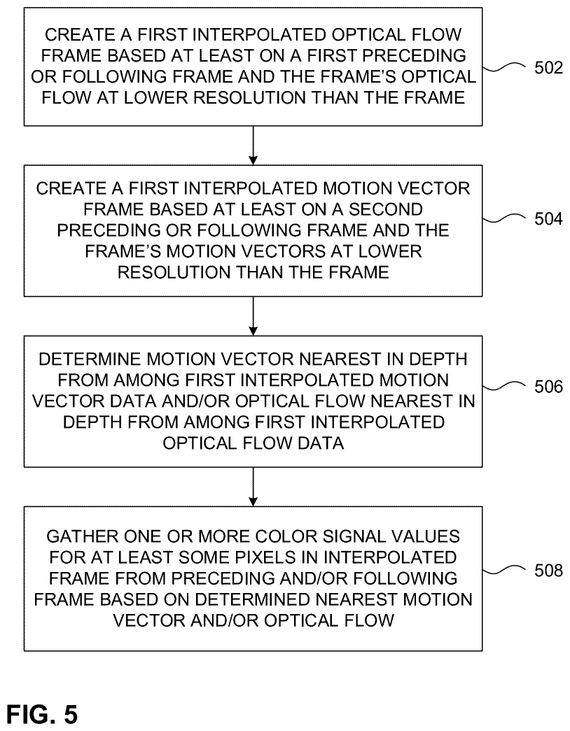

FIG. 5 is a flow diagram of a method of generating an interpolated image frame using reduced-resolution processing, consistent with an example embodiment. Here, a first interpolated optical flow frame is generated at 502, based at least on a first preceding or following frame and the frame's optical flow, at a resolution less than the first preceding or following frame. In a further example, interpolated optical flow frames may be generated based on each of the preceding and following image frames and their respective optical flow. At 404, a first interpolated motion vector frame is similarly generated based at least on a second preceding or following frame and that frame's motion vectors, also at a resolution less than the second preceding or following frame. In further examples, interpolated motion vector frames based on each of the preceding and following image frames and their respective motion vectors may be generated. The interpolated motion vector and optical flow frames may again be populated using a scatter-and-gather method as described in previous examples, may be warped, may be hole-filled, and/or may undergo other such processing.

At 506, the motion vector nearest in depth from among the first interpolated motion vector data may be determined as part of a scatter operation to resolve write collisions, such as using the methods and equations described in the example of FIG. 1. The optical flow nearest in depth may similarly be determined from among the first interpolated optical flow data. One or more color signal values are gathered from at least some pixels in the interpolated frame from the preceding and/or following frames based on the determined nearest motion vector and/or optical flow at 508. In a more detailed example, color signal values for the first interpolated optical flow frame are gathered from at least the preceding image frame from which the first interpolated optical flow frame is derived, and color signal values for the first interpolated motion vector frame are gathered from at least the following image frame from which the first interpolated motion vector frame is derived. In a further example, second interpolated optical flow frames and motion vector frames are also produced at a lower resolution than the rendered image frames and color signal values are gathered for such frames at 508, such as a second interpolated optical flow frame based at least on a following rendered image frame and a second interpolated motion vector frame based at least on a preceding rendered image frame. This process may therefore generate both interpolated motion vector and optical flow frames based on both the preceding and following rendered image frames, resulting in four interpolated image frames that may in some examples comprise frames at lower resolution than the preceding and following rendered image frames such as to provide reduced resolution input to a neural network. These four frames in a further example may be used (e.g., at full resolution) as candidate frames for blending to create an interpolated output image, such as using blending coefficients generated by a neural network using input tensor data such as the four candidate interpolated image frames and their associated depth information.

Various parameters in the examples presented herein, such as blending coefficients and other such parameters, may be determined using machine learning techniques such as a trained neural network. In some examples, a neural network may comprise a graph comprising nodes to model neurons in a brain. In this context, a “neural network” means an architecture of a processing device defined and/or represented by a graph including nodes to represent neurons that process input signals to generate output signals, and edges connecting the nodes to represent input and/or output signal paths between and/or among neurons represented by the graph. In particular implementations, a neural network may comprise a biological neural network, made up of real biological neurons, or an artificial neural network, made up of artificial neurons, for solving artificial intelligence (AI) problems, for example. In an implementation, such an artificial neural network may be implemented by one or more computing devices such as computing devices including a central processing unit (CPU), graphics processing unit (GPU), digital signal processing (DSP) unit and/or neural processing unit (NPU), just to provide a few examples. In a particular implementation, neural network weights associated with edges to represent input and/or output paths may reflect gains to be applied and/or whether an associated connection between connected nodes is to be excitatory (e.g., weight with a positive value) or inhibitory connections (e.g., weight with negative value). In an example implementation, a neuron may apply a neural network weight to input signals, and sum weighted input signals to generate a linear combination.

In one example embodiment, edges in a neural network connecting nodes may model synapses capable of transmitting signals (e.g., represented by real number values) between neurons. Responsive to receipt of such a signal, a node/neural may perform some computation to generate an output signal (e.g., to be provided to another node in the neural network connected by an edge). Such an output signal may be based, at least in part, on one or more weights and/or numerical coefficients associated with the node and/or edges providing the output signal. For example, such a weight may increase or decrease a strength of an output signal. In a particular implementation, such weights and/or numerical coefficients may be adjusted and/or updated as a machine learning process progresses. In an implementation, transmission of an output signal from a node in a neural network may be inhibited if a strength of the output signal does not exceed a threshold value.

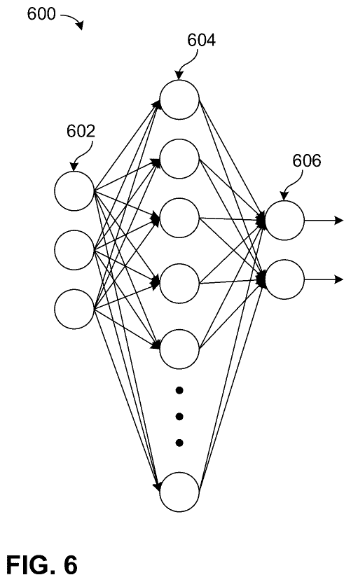

FIG. 6 is a schematic diagram of a neural network 600 formed in “layers” in which an initial layer is formed by nodes 602 and a final layer is formed by nodes 606. All or a portion of features of neural network 600 may be implemented various embodiments of systems described herein. Neural network 600 may include one or more intermediate layers, shown here by intermediate layer of nodes 604. Edges shown between nodes 602 and 604 illustrate signal flow from an initial layer to an intermediate layer. Likewise, edges shown between nodes 604 and 606 illustrate signal flow from an intermediate layer to a final layer. Although FIG. 6 shows each node in a layer connected with each node in a prior or subsequent layer to which the layer is connected, i.e., the nodes are fully connected, other neural networks will not be fully connected but will employ different node connection structures. While neural network 600 shows a single intermediate layer formed by nodes 604, other implementations of a neural network may include multiple intermediate layers formed between an initial layer and a final layer.

According to an embodiment, a node 602, 604 and/or 606 may process input signals (e.g., received on one or more incoming edges) to provide output signals (e.g., on one or more outgoing edges) according to an activation function. An “activation function” as referred to herein means a set of one or more operations associated with a node of a neural network to map one or more input signals to one or more output signals. In a particular implementation, such an activation function may be defined based, at least in part, on a weight associated with a node of a neural network. Operations of an activation function to map one or more input signals to one or more output signals may comprise, for example, identity, binary step, logistic (e.g., sigmoid and/or soft step), hyperbolic tangent, rectified linear unit, Gaussian error linear unit, Softplus, exponential linear unit, scaled exponential linear unit, leaky rectified linear unit, parametric rectified linear unit, sigmoid linear unit, Swish, Mish, Gaussian and/or growing cosine unit operations. It should be understood, however, that these are merely examples of operations that may be applied to map input signals of a node to output signals in an activation function, and claimed subject matter is not limited in this respect.

Additionally, an “activation input value” as referred to herein means a value provided as an input parameter and/or signal to an activation function defined and/or represented by a node in a neural network. Likewise, an “activation output value” as referred to herein means an output value provided by an activation function defined and/or represented by a node of a neural network. In a particular implementation, an activation output value may be computed and/or generated according to an activation function based on and/or responsive to one or more activation input values received at a node. In a particular implementation, an activation input value and/or activation output value may be structured, dimensioned and/or formatted as “tensors”. Thus, in this context, an “activation input tensor” as referred to herein means an expression of one or more activation input values according to a particular structure, dimension and/or format. Likewise in this context, an “activation output tensor” as referred to herein means an expression of one or more activation output values according to a particular structure, dimension and/or format.

In particular implementations, neural networks may enable improved results in a wide range of tasks, including image recognition, speech recognition, just to provide a couple of example applications. To enable performing such tasks, features of a neural network (e.g., nodes, edges, weights, layers of nodes and edges) may be structured and/or configured to form “filters” that may have a measurable/numerical state such as a value of an output signal. Such a filter may comprise nodes and/or edges arranged in “paths” and are to be responsive to sensor observations provided as input signals. In an implementation, a state and/or output signal of such a filter may indicate and/or infer detection of a presence or absence of a feature in an input signal.

In particular implementations, intelligent computing devices to perform functions supported by neural networks may comprise a wide variety of stationary and/or mobile devices, such as, for example, automobile sensors, biochip transponders, heart monitoring implants, Internet of things (IoT) devices, kitchen appliances, locks or like fastening devices, solar panel arrays, home gateways, smart gauges, robots, financial trading platforms, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio or video devices, personal navigation devices, just to provide a few examples.

According to an embodiment, a neural network may be structured in layers such that a node in a particular neural network layer may receive output signals from one or more nodes in an upstream layer in the neural network, and provide an output signal to one or more nodes in a downstream layer in the neural network. One specific class of layered neural networks may comprise a convolutional neural network (CNN) or space invariant artificial neural networks (SIANN) that enable deep learning. Such CNNs and/or SIANNs may be based, at least in part, on a shared-weight architecture of a convolution kernels that shift over input features and provide translation equivariant responses. Such CNNs and/or SIANNs may be applied to image and/or video recognition, recommender systems, image classification, image segmentation, medical image analysis, natural language processing, brain-computer interfaces, financial time series, just to provide a few examples.

Another class of layered neural network may comprise a recursive neural network (RNN) that is a class of neural networks in which connections between nodes form a directed cyclic graph along a temporal sequence. Such a temporal sequence may enable modeling of temporal dynamic behavior. In an implementation, an RNN may employ an internal state (e.g., memory) to process variable length sequences of inputs. This may be applied, for example, to tasks such as unsegmented, connected handwriting recognition or speech recognition, just to provide a few examples. In particular implementations, an RNN may emulate temporal behavior using finite impulse response (FIR) or infinite impulse response (IIR) structures. An RNN may include additional structures to control stored states of such FIR and IIR structures to be aged. Structures to control such stored states may include a network or graph that incorporates time delays and/or has feedback loops, such as in long short-term memory networks (LSTMs) and gated recurrent units.

According to an embodiment, output signals of one or more neural networks (e.g., taken individually or in combination) may at least in part, define a “predictor” to generate prediction values associated with some observable and/or measurable phenomenon and/or state. In an implementation, a neural network may be “trained” to provide a predictor that is capable of generating such prediction values based on input values (e.g., measurements and/or observations) optimized according to a loss function. For example, a training process may employ backpropagation techniques to iteratively update neural network weights to be associated with nodes and/or edges of a neural network based, at least in part on “training sets.” Such training sets may include training measurements and/or observations to be supplied as input values that are paired with “ground truth” observations or expected outputs. Based on a comparison of such ground truth observations and associated prediction values generated based on such input values in a training process, weights may be updated according to a loss function using backpropagation. The neural networks employed in various examples can be any known or future neural network architecture, including traditional feed-forward neural networks, convolutional neural networks, or other such networks.

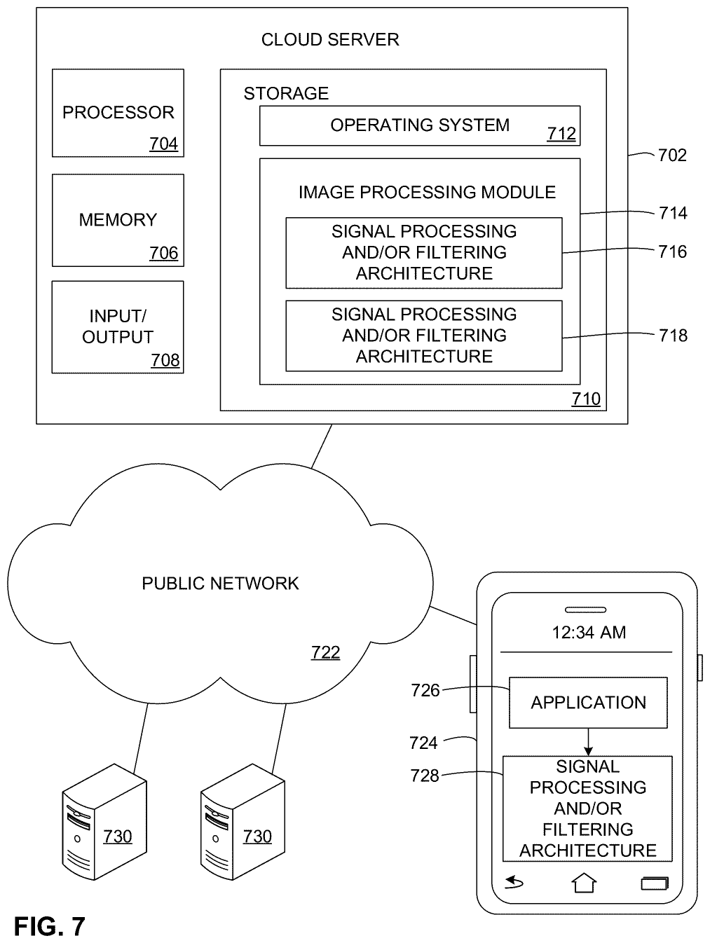

FIG. 7 shows a computing environment in which one or more image processing and/or filtering architectures (e.g., image processing stages, FIGS. 2 and 3A-3B) may be employed, consistent with an example embodiment. Here, a cloud server 702 includes a processor 704 operable to process stored computer instructions, a memory 706 operable to store computer instructions, values, symbols, parameters, etc., for processing on the cloud server, and input/output 708 such as network connections, wireless connections, and connections to accessories such as keyboards and the like. Storage 710 may be nonvolatile, and may store values, parameters, symbols, content, code, etc., such as code for an operating system 712 and code for software such as image processing module 714. Image processing module 714 may comprise multiple signal processing and/or filtering architectures 716 and 718, which may be operable to render and/or process images. Signal processing and/or filtering architectures may be available for processing images or other content stored on a server, or for providing remote service or “cloud” service to remote computers such as computers 730 connected via a public network 722 such as the Internet.

Smartphone 724 may also be coupled to a public network in the example of FIG. 7, and may include an application 726 that utilizes image processing and/or filtering architecture 728 for processing rendered images such as a video game, virtual reality application, or other application 726. Image processing and/or filtering architectures 716, 718, and 728 may provide faster and more efficient computation of effects such as interpolating between frames of a rendered image sequence in an environment such as a smartphone, and can provide for longer battery life due to reduction in power needed to impart a desired effect and/or compute a result. In some examples, a device such as smartphone 724 may use a dedicated signal processing and/or filtering architecture 728 for some tasks, such as relatively simple image rendering or processing that does not require substantial computational resources or electrical power, and offloads other processing tasks to a signal processing and/or filtering architecture 716 or 718 of cloud server 702 for more complex tasks.

Signal processing and/or filtering architectures 716, 718, and 728 of FIG. 7 may, in some examples, be implemented in software, where various nodes, tensors, and other elements of processing stages (e.g., processing blocks in FIG. 1) may be stored in data structures in a memory such as 706 or storage 710. In other examples, signal processing and/or filtering architectures 716, 718, and 728 may be implemented in hardware, such as a neural network structure that is embodied within the transistors, resistors, and other elements of an integrated circuit. In an alternate example, signal processing and/or filtering architectures 716, 718 and 728 may be implemented in a combination of hardware and software, such as a neural processing unit (NPU) having software-configurable weights, network size and/or structure, and other such configuration parameters.

Trained neural network 234 (FIG. 2) and other neural networks as described herein in particular examples, may be formed in whole or in part by and/or expressed in transistors and/or lower metal interconnects (not shown) in processes (e.g., front end-of-line and/or back-end-of-line processes) such as processes to form complementary metal oxide semiconductor (CMOS) circuitry. The various blocks, neural networks, and other elements disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Storage media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

Computing devices such as cloud server 702, smartphone 724, and other such devices that may employ signal processing and/or filtering architectures can take many forms and can include many features or functions including those already described and those not described herein.

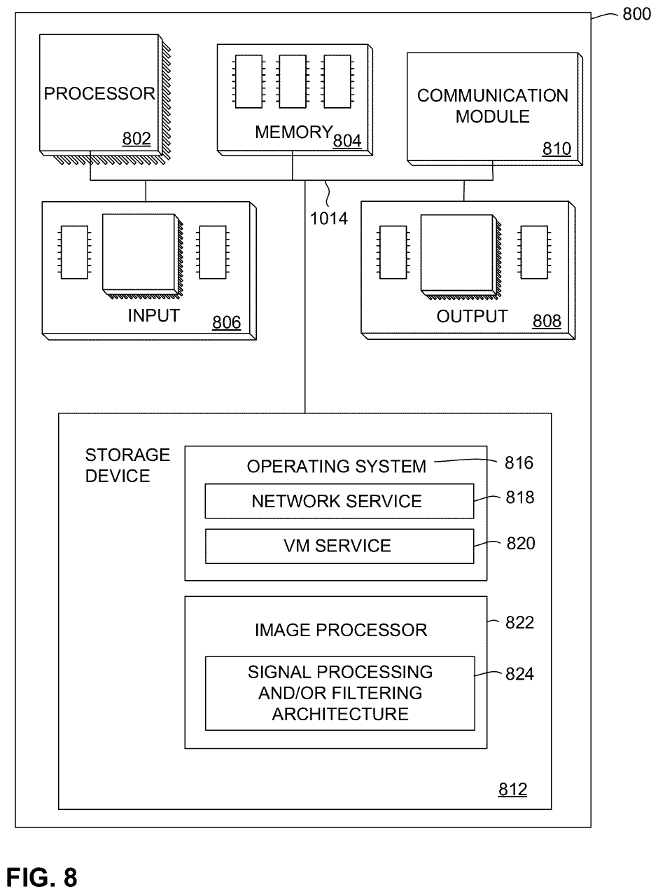

FIG. 8 shows a block diagram of a general-purpose computerized system, consistent with an example embodiment. FIG. 8 illustrates only one particular example of computing device 800, and other computing devices 800 may be used in other embodiments. Although computing device 800 is shown as a standalone computing device, computing device 800 may be any component or system that includes one or more processors or another suitable computing environment for executing software instructions in other examples, and need not include all of the elements shown here.

As shown in the specific example of FIG. 8, computing device 800 includes one or more processors 802, memory 804, one or more input devices 806, one or more output devices 808, one or more communication modules 810, and one or more storage devices 812.

Computing device 800, in one example, further includes an operating system 816 executable by computing device 800. The operating system includes in various examples services such as a network service 818 and a virtual machine service 820 such as a virtual server. One or more applications, such as image processor 822 are also stored on storage device 812, and are executable by computing device 800.

Each of components 802, 804, 806, 808, 810, and 812 may be interconnected (physically, communicatively, and/or operatively) for inter-component communications, such as via one or more communications channels 814. In some examples, communication channels 814 include a system bus, network connection, inter-processor communication network, or any other channel for communicating data. Applications such as image processor 822 and operating system 816 may also communicate information with one another as well as with other components in computing device 800.

Processors 802, in one example, are configured to implement functionality and/or process instructions for execution within computing device 800. For example, processors 802 may be capable of processing instructions stored in storage device 812 or memory 804. Examples of processors 1002 include any one or more of a microprocessor, a controller, a central processing unit (CPU), a graphics processing unit (GPU), a neural processing unit (NPU), an image signal processor (ISP), a digital signal processor (DSP), an application specific integrated circuit (ASIC), a field-programmable gate array (FPGA), or similar discrete or integrated logic circuitry.

One or more storage devices 812 may be configured to store information within computing device 800 during operation. Storage device 812, in some examples, is known as a computer-readable storage medium. In some examples, storage device 812 comprises temporary memory, meaning that a primary purpose of storage device 812 is not long-term storage. Storage device 812 in some examples is a volatile memory, meaning that storage device 812 does not maintain stored contents when computing device 800 is turned off. In other examples, data is loaded from storage device 812 into memory 804 during operation. Examples of volatile memories include random access memories (RAM), dynamic random access memories (DRAM), static random access memories (SRAM), and other forms of volatile memories known in the art. In some examples, storage device 812 is used to store program instructions for execution by processors 802. Storage device 812 and memory 804, in various examples, are used by software or applications running on computing device 800 such as image processor 1022 to temporarily store information during program execution.

Storage device 812, in some examples, includes one or more computer-readable storage media that may be configured to store larger amounts of information than volatile memory.

Storage device 812 may further be configured for long-term storage of information. In some examples, storage devices 812 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 800, in some examples, also includes one or more communication modules 810. Computing device 800 in one example uses communication module 810 to communicate with external devices via one or more networks, such as one or more wireless networks. Communication module 810 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, computing device 800 uses communication module 810 to wirelessly communicate with an external device such as via public network 722 of FIG. 7.

Computing device 800 also includes in one example one or more input devices 806. Input device 806, in some examples, is configured to receive input from a user through tactile, audio, or video input. Examples of input device 806 include a touchscreen display, a mouse, a keyboard, a voice responsive system, video camera, microphone or any other type of device for detecting input from a user.

One or more output devices 808 may also be included in computing device 800. Output device 808, in some examples, is configured to provide output to a user using tactile, audio, or video stimuli. Output device 808, in one example, includes a display, a sound card, a video graphics adapter card, or any other type of device for converting a signal into an appropriate form understandable to humans or machines. Additional examples of output device 808 include a speaker, a light-emitting diode (LED) display, a liquid crystal display (LCD or OLED), or any other type of device that can generate output to a user.

Computing device 800 may include operating system 816. Operating system 816, in some examples, controls the operation of components of computing device 800, and provides an interface from various applications such as image processor 822 to components of computing device 800. For example, operating system 816, in one example, facilitates the communication of various applications such as image processor 822 with processors 802, communication unit 810, storage device 812, input device 806, and output device 808. Applications such as image processor 822 may include program instructions and/or data that are executable by computing device 800. As one example, image processor 822 may implement a signal processing and/or filtering architecture 824 to perform image processing tasks or rendered image processing tasks such as those described above, which in a further example comprises using signal processing and/or filtering hardware elements such as those described in the above examples. These and other program instructions or modules may include instructions that cause computing device 800 to perform one or more of the other operations and actions described in the examples presented herein.

Features of example computing devices in FIGS. 7 and 8 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU), image signal processor (ISP) and/or neural processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112(f) so that it is specifically intended that 35 USC § 112(f) not be implicated by use of the term “computing device,” “processor,” “processing unit,” “processing circuit” and/or similar terms; however, if it is determined, for some reason not immediately apparent, that the foregoing understanding cannot stand and that 35 USC § 112(f), therefore, necessarily is implicated by the use of the term “computing device” and/or similar terms, then, it is intended, pursuant to that statutory section, that corresponding structure, material and/or acts for performing one or more functions be understood and be interpreted to be described at least in the figures and text associated with the foregoing figures of the present patent application.

The term electronic file and/or the term electronic document, as applied herein, refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format).

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

What is claimed is:

1. A method, comprising:
creating first interpolated optical flow data based, at least in part, on an optical flow from a preceding frame, an optical flow from a following frame, or a combination thereof, the first interpolated optical flow data having a resolution reduced relative to the preceding frame, the following frame, or a combination thereof;
creating first interpolated motion vector data based, at least in part, on motion vectors from a preceding frame, a following frame, or a combination thereof, the first interpolated motion vector data having a resolution reduced relative to the preceding frame, the following frame, or the combination thereof;
determining a motion vector nearest in depth from among the first interpolated motion vector data or an optical flow nearest in depth from among the first interpolated optical flow data, or a combination thereof, for each pixel of an interpolated frame; and
selectively gathering one or more color signal values for at least some pixels in the interpolated frame from the preceding frame or the following frame, or a combination thereof, based, at least in part, on the determined at least one nearest in depth motion vector, or at least one nearest in depth optical flow, or a combination thereof.

2. The method of claim 1, further comprising selecting between the first interpolated optical flow data and the first interpolated motion vector data for at least one pixel in the interpolated frame to provide a selected first interpolated optical flow data or first interpolated motion vector data, and using the selected first interpolated optical flow data or first interpolated motion vector data to gather at least one color signal value for the at least one pixel.

3. The method of claim 1, further comprising blending color signal values from the preceding frame and the following frame based, at least in part, on a computed blending value, a warped interpolated optical flow record or a warped interpolated motion vector record, or a combination thereof, for one or more pixels in the interpolated frame.

4. The method of claim 3, and further comprising computing the at least one computed blending value using a trained neural network.

5. The method of claim 4, wherein the at least one computed blending value is at lower spatial resolution than a spatial resolution of the interpolated frame, and the at least one computed blending value is upsampled to the spatial resolution of the interpolated frame.

6. The method of claim 4, wherein the trained neural network is provided with a warped interpolated optical flow frame, a warped interpolated motion vector frame, rendered object depth parameters for at least one of the preceding frame and the following frame, a disocclusion mask, or a combination thereof.

7. The method of claim 1, wherein creating the first interpolated optical flow data or creating the first interpolated motion vector data, or a combination thereof, further comprises retaining a scattered element for one or more pixels in the interpolated frame having a nearest depth.

8. The method of claim 7, wherein creating the first interpolated optical flow data or creating the first interpolated motion vector data, or a combination thereof, further comprises filling any unfilled pixels with a pixel value having the nearest depth from a mask area comprising one or more pixels near the unfilled pixel.

9. The method of claim 1, further comprising interpolating or warping the first interpolated optical flow data or the first interpolated motion vector data, or a combination thereof, to a time between the preceding frame and the following frame.

10. The method of claim 1, further comprising:
creating second interpolated optical flow data based, at least in part, on optical flow from a preceding frame or a following frame, such that one of the first interpolated optical flow data and second interpolated optical flow data are based on the preceding frame and the other of the first interpolated optical flow data and the second interpolated optical flow data are based on the following frame, the second interpolated optical flow data having a resolution reduced relative to the preceding frame or the following frame;
creating second interpolated motion vector data based, at least in part, on motion vectors from a preceding frame or a following frame such that one of the first interpolated motion vector data and the second interpolated motion vector data are based on the preceding frame and the other of the first interpolated motion vector data and second interpolated motion vector data are based on the following frame, the second interpolated motion vector data having a resolution reduced relative to the preceding frame or the following frame; and
using the first interpolated optical flow data, the second interpolated optical flow data, the first interpolated motion vector data, and the second interpolated motion vector data in determining at least one closest motion vector or a closest optical flow, or a combination thereof, for one or more pixels of an interpolated frame and in selectively gathering one or more color signal values for the one or more pixels in the interpolated frame from the preceding frame or the following frame, or a combination thereof, based, at least in part, on the determined at least one closest motion vector or at least one closest optical flow, or a combination thereof.

11. A computing device, comprising:
a memory comprising one more storage devices; and
one or more processors coupled to the memory, the one or more processors operable to execute instructions stored in the memory to, for a rendered image sequence:
create first interpolated optical flow data based, at least in part, on an optical flow from a preceding frame, a following frame, or a combination thereof, the first interpolated optical flow data having a resolution reduced relative to the preceding frame, the following frame, or a combination thereof;
create first interpolated motion vector data based, at least in part, on motion vectors from a preceding frame, a following frame, or a combination thereof, the first interpolated motion vector data having a resolution reduced relative to the preceding frame, the following frame, or the combination thereof;
determine a motion vector nearest in depth from among the first interpolated motion vector data or an optical flow nearest in depth from among the first interpolated optical flow data, or a combination thereof, for each pixel of an interpolated frame; and
selectively gather one or more color signal values for at least some pixels in the interpolated frame from the preceding frame or the following frame, or a combination thereof, based, at least in part, on the determined at least one nearest in depth motion vector, or at least one nearest in depth optical flow, or a combination thereof.

12. The computing device of claim 11, the one or more processors further operable to execute instructions stored in the memory to select between the first interpolated optical flow data and the first interpolated motion vector data for at least one pixel in the interpolated frame to provide a selected first interpolated optical flow data or first interpolated motion vector data, and to use the selected first interpolated optical flow data or first interpolated motion vector data to gather at least one color signal value for the at least one pixel.

13. The computing device of claim 11, the one or more processors further operable to execute instructions stored in the memory to blend color signal values from the preceding frame and the following frame based, at least in part, on at least one computed blending value, a warped interpolated optical flow data, and a warped interpolated motion vector data for one or more pixels in the interpolated frame.

14. The computing device of claim 13, wherein the at least one blending value is predicted using a trained neural network.

15. The computing device of claim 14, wherein the at least one predicted blending value is at lower spatial resolution than a spatial resolution of the interpolated frame, and the predicted blending value is upsampled to the spatial resolution of the interpolated frame.

16. The computing device of claim 14, wherein the trained neural network is provided with a warped interpolated optical flow frame, a warped interpolated motion vector frame, rendered object depth parameters for at least one of the preceding frame and the following frame, a disocclusion mask, or a combination thereof.

17. The computing device of claim 11, wherein creating the first interpolated optical flow data or creating the first interpolated motion vector data, or a combination thereof, further comprises retaining a scattered element for one or more pixels in the interpolated frame having a nearest depth.

18. The computing device of claim 17, wherein creating the first interpolated optical flow data or creating the first interpolated motion vector data, or a combination thereof, further comprises filling any unfilled pixels with a pixel value having the nearest depth from a mask area comprising one or more pixels near the unfilled pixel.

19. The computing device of claim 11, the one or more processors further operable to execute instructions stored in the memory to:
create second interpolated optical flow data based, at least in part, on optical flow from a preceding frame or a following frame such that one of the first interpolated optical flow data and the second interpolated optical flow data are based on the preceding frame and the other of the first interpolated optical flow data and the second interpolated optical flow data are based on the following frame, the second interpolated optical flow data having a resolution reduced relative to the preceding frame or the following frame;
create second interpolated motion vector data, at least in part, on motion vectors from a preceding frame or a following frame such that one of the first interpolated motion vector data and the second interpolated motion vector data are based on the preceding frame and the other of the first interpolated motion vector data and the second interpolated motion vector data are based on the following frame, the second interpolated motion vector data having a resolution reduced relative to the preceding frame or the following frame; and
use the first interpolated optical flow data, the second interpolated optical flow data, the first interpolated motion vector data, and the second interpolated motion vector data to determine at least one closest motion vector or a closest optical flow, or a combination thereof, for one or more pixels of an interpolated frame and in selectively gathering one or more color signal values for the one or more pixels in the interpolated frame from the preceding frame or the following frame, or a combination thereof, based, at least in part, on the determined at least one closest motion vector or at least one closest optical flow, or a combination thereof.

20. An article comprising a non-transitory computer-readable medium to store computer-readable hardware description language code for fabrication of a device, the device comprising:
an optical flow processing unit operable to create first interpolated optical flow data based, at least in part, on an optical flow from a preceding frame, a following frame, or a combination thereof, the first interpolated optical flow data having a resolution reduced relative to the preceding frame, the following frame, or a combination thereof;
a motion vector processing unit operable to create first interpolated motion vector data based, at least in part, on motion vectors from a preceding frame, a following frame, or a combination thereof, the first interpolated motion vector data having a resolution reduced relative to the preceding frame, the following frame, or the combination thereof;
a scatter processing unit operable to determine a motion vector nearest in depth from among the first interpolated motion vector data or an optical flow nearest in depth from among the first interpolated optical flow data, or a combination thereof, for each pixel of an interpolated frame; and
a gather processing unit operable to selectively gather one or more color signal values for at least some pixels in the interpolated frame from the preceding frame or the following frame, or a combination thereof, based, at least in part, on the determined at least one nearest in depth motion vector, or at least one nearest in depth optical flow, or a combination thereof.
